(19) United States
(12) Patent Application Publication
(10) Pub. No.: US 2026/0062332 A1
(43) Pub. Date: Mar. 5, 2026

(54) COMPREHENSIVE TREATMENT SYSTEM AND TREATMENT PROCESS FOR ORGANIC WASTEWATER AND TAIL GAS OF CONTAMINATED SITES

(71) Applicant: NANJING UNIVERSITY, Nanjing (CN)

(72) Inventors: Peng SHI, Nanjing (CN); Zhiwei Zhang, Nanjing (CN); Lifang Chen, Nanjing (CN); Xin Qiu, Nanjing (CN)

(21) Appl. No.: 18/925,973

(22) Filed: Oct. 24, 2024

(30) Foreign Application Priority Data
Aug. 30, 2024 (CN) 202411208422.8

(51) Int. Cl. C02F 9/00; B01D 53/04; C02F 1/00; C02F 1/32; C02F 1/66; C02F 1/72; C02F 101/30

(52) U.S. Cl. CPC C02F 9/00; B01D 53/0423; C02F 1/008; B01D 2257/708; C02F 1/325; C02F 1/66; C02F 1/725; C02F 2101/30; C02F 2201/3227; C02F 2301/08; C02F 2305/10

(57) ABSTRACT

A comprehensive treatment system and treatment process for organic wastewater and tail gas of contaminated sites is disclosed, which belongs to the field of soil remediation. The system of the present invention comprises a wastewater treatment unit and a tail gas treatment unit. The wastewater treatment unit comprises an oxidant addition unit, and first and second ultraviolet reaction units connected in sequence; the oxidant addition unit is used to add oxidants to the wastewater to be treated which is treated by the ultraviolet photocatalytic oxidation technology. The tail gas treatment unit includes several adsorption towers connected in parallel and filled with adsorbent resin. The main application of the present invention is to reasonably and efficiently treat the wastewater and tail gas extracted by the extraction unit, and it occupies a small area and is easy to skid-mount, install, disassemble and transport.

### TECHNICAL FIELD

The present invention relates to the field of soil remediation, and more specifically, relates to a comprehensive treatment system and treatment process for organic wastewater and tail gas of contaminated sites.

### BACKGROUND

In recent years, with the upgrading of industrial structures and the acceleration of urbanization in China, a large number of polluting enterprises have been relocated or shut down, leaving behind contaminated and environmentally risky land parcels known as contaminated sites. The multiphase extraction system is a commonly used remediation process in current contaminated site remediation projects. As stipulated in the group standard T/ACEF113-2023 “Technical Specification for Organic Contaminated Land Remediation-Multiphase Extraction”, the multiphase extraction system is mainly constituted of an extraction unit and a separation and purification unit. The multiphase extraction system extracts pollutants such as soil gases and contaminated groundwater onto the ground, and after gas and liquid separation, the separated pollutants in multiple phases are treated by pollutant treatment devices.

Effective treatment of tail gas and wastewater after extraction and separation is crucial in the remediation of contaminated sites. In current engineering, activated carbon adsorption is the simplest and most effective organic waste gas treatment technology, but due to improper management or operation, it is difficult to sustainably and stably meet the emission and collection standards. Moreover, the disposal cost of waste activated carbon generated after adsorption is relatively high. For high concentration of wastewater to be treated, the traditional activated sludge methods cannot be used for on-site treatment, and in most cases, the techniques of Fenton or electrolysis processes are used for degradation. However, the Fenton process produces Fenton iron sludge, which causes secondary pollution; and the electrolysis process produces flammable and explosive hydrogen gas, which poses significant safety hazards during on-site disposal. At the same time, the engineering devices or systems used in the above engineering technologies occupy a large area, and installation and disassembly thereof are time-consuming and laborious, so they cannot be moved between project sites.

Therefore, there is an urgent need for a comprehensive treatment system for organic wastewater and tail gas of contaminated sites that can reasonably and efficiently treat the wastewater and tail gas extracted by the extraction unit, occupy a small area and is easy to skid-mount, install, disassemble, and transport.

### SUMMARY OF THE INVENTION

### 1. Technical Problems to Be Solved by the Present Invention

Aiming at solving the problems in the prior art of secondary pollution and hazardous gas generation in the on-site treatment of wastewater and tail gas extracted by extraction units in the remediation of contaminated sites, and the problems that the treatment device occupies a large area and is inconvenient to install and disassemble, a comprehensive treatment system and treatment process for organic wastewater and tail gas of contaminated sites are provided.

### 2. Technical Solutions

To achieve the above objectives, the technical solutions provided by the present invention are as follows.

The present invention provides a comprehensive treatment system for organic wastewater and tail gas of contaminated sites, which comprises a wastewater treatment unit and a tail gas treatment unit;

the wastewater treatment unit comprises an oxidant addition unit, a first ultraviolet reaction unit, and a second ultraviolet reaction unit connected in sequence;

the oxidant addition unit is connected to the wastewater to be treated and is used to add oxidants to the wastewater to be treated;

the first ultraviolet reaction unit comprises several first ultraviolet reactors in which several first ultraviolet lamps are provided; when the number of the first ultraviolet reactors is ≥2, the series/parallel connection mode of the first ultraviolet reactors can be switched, and the first ultraviolet reactors meet the requirement that the residence time of the wastewater to be treated in the first ultraviolet reactors is t₁; the second ultraviolet reaction unit comprises several second ultraviolet reactors in which several second ultraviolet lamps are provided; when the number of the second ultraviolet reactors is ≥2, the second ultraviolet reactors are connected in series; and the second ultraviolet reactors meet the requirement that the residence time of the wastewater to be treated in the second ultraviolet reactors is t₂;

the residence time t₁ is less than the residence time t₂, and the power of the first ultraviolet lamp is greater than that of the second ultraviolet lamp;

the tail gas treatment unit comprises several adsorption towers which are connected in parallel and filled with absorbent resin; the absorbent resin meets the requirement of a specific surface area of ≥1000 m²/g.

It should be noted that ultraviolet photocatalytic oxidation technology is used to treat the wastewater to be treated. The wastewater to be treated passes through the first ultraviolet reactor in the first ultraviolet reaction unit, and under conditions of higher ultraviolet intensity, higher oxidant concentration, and lower residence time, the organic matters in the wastewater can be rapidly oxidized, and this stage can be called the rapid oxidation stage. The wastewater then passes through the second ultraviolet reactor of the second ultraviolet reaction unit, and under conditions of lower ultraviolet intensity, lower oxidant concentration, and higher residence time, the organic matters in the wastewater undergo further deep oxidation, which can be called the deep oxidation stage. By the action of oxidants and ultraviolet light, strong oxidizing free radicals are generated to achieve thorough oxidation of organic pollutants and generate water and carbon dioxide without secondary pollution generation. On the other hand, the oxidation process includes a rapid oxidation stage and a deep oxidation stage, and through the segmented gradient oxidation process, the utilization rate and oxidation effect of oxidants are greatly improved, and operating costs are reduced.

The tail gas treatment unit is used to adsorb VOCs in tail gas and the treatment performed with absorbent resin has the advantages of stable operation and low replacement frequency or the like.

Preferably, reference may be made to the invention patent with publication number CN102391407A for the absorbent resin, and the absorbent resin is stable in performance, easy to regenerate, and can be used for a long time without replacement or supplement.

For example, the first ultraviolet reactor may be a tubular reactor, and the second ultraviolet reactor may be a trough reactor.

The wastewater to be treated is organic wastewater extracted and separated from the soil in the contaminated sites by the multiphase extraction system; while the tail gas is organic waste gas extracted and separated from the soil in the contaminated sites by the multiphase extraction system.

Furthermore, the residence time t₁ of the wastewater to be treated in the first ultraviolet reactor is 0.5-5 minutes;
and the residence time t₂ of the wastewater to be treated in the second ultraviolet reactor is 10-100 minutes.

Furthermore, the first ultraviolet lamps are arranged parallel to the direction of water flow.

By arranging the first ultraviolet lamps parallel to the direction of water flow, the structure of the first ultraviolet reactor can be made more compact to reduce its volume.

Further, the number of the first ultraviolet lamps increases as the volume of the first ultraviolet reactor increases.

Further, the power of the first ultraviolet lamp is greater than 1 kW.

Even further, the wavelength of ultraviolet light emitted by the first ultraviolet lamps is 200-400 nm.

Further, the second ultraviolet lamps are arranged perpendicular to the direction of water flow.

Through such an arrangement mode, maintenance and replacement can be carried out from the top of the second ultraviolet reactor, thereby saving space.

Further, the power of the second ultraviolet lamp is less than 1 kW.

Even further, the wavelength of the ultraviolet light emitted by the second ultraviolet lamps is mainly 254 nm.

Further, both the first ultraviolet lamp and the second ultraviolet lamp may be power-adjustable ultraviolet lamps.

Further, the oxidant addition unit comprises an oxidant storage tank and a first metering pump, and the first metering pump is connected to the oxidant storage tank and the first ultraviolet reaction unit respectively.

Even further, the oxidant storage tank is stored with an oxidant that can generate strong oxidizing free radicals under the action of ultraviolet light.

Furthermore, the oxidant is at least one of hydrogen peroxide and persulfate.

For example, the persulfate may be sodium persulfate or potassium persulfate.

Preferably, the oxidant is hydrogen peroxide, for which the reduction product is water, which is greener and safer, and it generates strong oxidizing hydroxyl radicals under the action of ultraviolet light.

Further, the wastewater treatment unit also comprises an acid solution addition unit, which includes an acid solution storage tank and a second metering pump, the second metering pump is connected to the acid solution storage tank and the first ultraviolet reaction unit respectively.

It should be noted that the acid solution is used to adjust the pH value of the wastewater to be treated, in order to enhance the oxidation effect of the oxidant.

Further, the acid solution is one or both of hydrochloric acid or sulfuric acid.

Further, the acid solution addition unit may be provided between the first reaction unit and the oxidant addition unit.

Further, the second ultraviolet reaction unit is connected to the tail gas treatment unit;

when the wastewater treated by the second ultraviolet reaction unit fails to meet the standard, some of the adsorption towers in the tail gas treatment unit are used to adsorb pollutants in the wastewater.

Further, a first flowmeter, a temperature sensor, and a pH sensor are provided between the first ultraviolet reaction unit and the wastewater to be treated;

and a second flowmeter is provided between the tail gas treatment unit and the tail gas.

Further, the system also comprises an automatic control unit, which is electrically connected to the wastewater treatment unit, the tail gas treatment unit, the oxidant addition unit, and the acid solution addition unit.

The automatic control unit may be a programmable logic controller, and the system automatically controls individual units through the control panel on the automatic control unit, including adjusting the power of the ultraviolet reactors. The values of all the instruments and the operating status of equipment can all be viewed and controlled through the control panel of the automatic control unit, and manual control and parameter modification can be performed, thereby realizing a high degree of automation.

For example, based on the flow rate, temperature, pH and other water quality indicators of the wastewater to be treated monitored by the first flowmeter, the temperature sensor and the pH sensor, as well as the input concentration data of pollutants, the amount of oxidant that needs to be added is calculated according to the target oxidant concentration set by the system, and the first metering pump is intelligently controlled to add a certain amount of oxidant to the wastewater to be treated.

Based on the flow rate, temperature, pH and other water quality indicators of the wastewater to be treated monitored by the first flowmeter, the temperature sensor and the pH sensor, as well as the input concentration data of pollutants, the required UV intensity is calculated according to the target UV dosage set by the system, and the power of the first ultraviolet lamp and the second ultraviolet lamp is intelligently controlled.

Further, the first ultraviolet reaction unit comprises a first ultraviolet reactor a, a first ultraviolet reactor b, and a first ultraviolet reactor c;
the first ultraviolet reactor a is provided with an interface a and an interface b,
the first ultraviolet reactor b is provided with an interface c and an interface d,
the first ultraviolet reactor c is provided with an interface e and an interface f,
the interfaces a, c, and e are respectively connected to the oxidant addition unit and the wastewater to be treated through pipelines, while the interfaces b, d, and f are connected to the second ultraviolet reaction unit through pipelines.

It should be noted that, when the flow rate of the wastewater to be treated is small and the concentration of pollutants is high, the first ultraviolet reactor a, the first ultraviolet reactor b, and the first ultraviolet reactor c are allowed to be connected in series by adjusting the pipeline connection or the like, which can increase the treatment time at higher UV intensity and higher oxidant concentration, and achieve rapid oxidation of high-concentration pollutants.

When the flow rate of the wastewater to be treated is larger and the concentration is lower, the first ultraviolet reactor a, the first ultraviolet reactor b, and the first ultraviolet reactor c are allowed to be connected in parallel by adjusting the pipeline connection or the like, which can achieve rapid oxidation of a large amount of wastewater to be treated and maintain a better oxidation effect.

On the other hand, one or two of the first ultraviolet reactors can be switched out of the system for cleaning, repair or the like. Taking the case where the first ultraviolet reactor a is switched out as an example, when it is necessary to clean the first ultraviolet reactor a, the first ultraviolet reactor b and the first ultraviolet reactor c keep running, and the wastewater is not allowed to pass through the first ultraviolet reactor a. Since there is no wastewater flowing through the first ultraviolet reactor a, it is convenient to perform operations such as maintenance and cleaning of the first ultraviolet reactor a while the system continuously operates. Similarly, other first ultraviolet reactors can be maintained and cleaned under the condition that the system continuously operates.

Further, valves may be provided on the pipelines to achieve series/parallel connection switching of the first ultraviolet reactor a, the first ultraviolet reactor b, and the first ultraviolet reactor c.

Further, the second ultraviolet reaction unit comprises a second ultraviolet reactor a and a second ultraviolet reactor b connected in series,
the second ultraviolet reactor a includes a water inlet a and a water outlet a, and the second ultraviolet reactor b includes a water inlet b and a water outlet b;
the water inlet a of the second ultraviolet reactor a is connected to the first ultraviolet reactor c, the water outlet a is connected to the water inlet b of the second ultraviolet reactor b, and the water outlet b is connected to the wastewater collection device.

The wastewater collection device is used to collect the wastewater that meets the standard after being treated.

For example, the wastewater collection device may be a reagent storage tank.

Further, the tail gas treatment unit comprises an adsorption tower a and an adsorption tower b connected in parallel,
the adsorption tower a comprises an air inlet and an air outlet, and the adsorption tower b comprises an air inlet and an air outlet;
the air inlet of the adsorption tower a and the air inlet of the adsorption tower b are connected to tail gas, and the air outlet of the adsorption tower a and the air outlet of the adsorption tower b are both in communication with the outside.

Further, the adsorption tower a further comprises a water inlet and a water outlet, wherein the water inlet of the adsorption tower a is connected to the water outlet b of the second ultraviolet reactor; and the water outlet of the adsorption tower a is connected to the wastewater collection device.

It should be noted that when the wastewater to be treated meets the standard after being treated by the wastewater treatment unit, it is collected by the wastewater collection device and then discharged. At this time, the adsorption tower a and the adsorption tower b are connected in parallel to treat the tail gas.

When the wastewater to be treated fails to meet the standard after being treated by the wastewater treatment unit, it needs to be further treated by the adsorption tower a so as to meet the standard. At this time, the adsorption tower a is switched to treat the wastewater to be treated, and the adsorption tower b treats the tail gas.

It should be additionally noted that the wastewater discharge standard may be the indirect discharge limit standards in Table 1 of the national standard GB 31571-2015 or the direct discharge limit standards in Table 1 of the national standard GB 31571-2015.

The various units used in the system and equipment reactors within the units may be combined and applied in different quantities according to treatment requirements, and the layout can be easily changed, thus making it suitable for a wider range of contaminated sites. The system occupies a small area and is easy to skid-mount, install, disassemble, and transport; moreover, the system has the advantages of high degree of automation, good treatment effect, stable operation, and low treatment cost or the like.

The present invention also provides a process of wastewater and tail gas treatment by using the comprehensive treatment system for organic wastewater and tail gas of contaminated sites described above, which comprises the following procedures:

adding oxidant and acid solution to the wastewater to be treated, then allowing the wastewater to be treated to enter the first ultraviolet reaction unit and then passing through the second ultraviolet reaction unit for ultraviolet photocatalytic oxidation treatment in the first ultraviolet reaction unit and the second ultraviolet reaction unit;

introducing the tail gas into the adsorption tower of the tail gas treatment unit for adsorption treatment;

discharging the wastewater if the wastewater to be treated meets the standard after the ultraviolet photocatalytic oxidation treatment; and introducing the wastewater into some adsorption towers in the tail gas treatment unit for treatment if the wastewater fails to meet the standard.

### 3. Beneficial Effects

As compared to the prior art, the technical solution provided according to the present invention has the following beneficial effects:

(1) for the comprehensive treatment system for organic wastewater and tail gas of contaminated sites provided according to the present invention, the wastewater treatment unit in the system comprises an oxidant addition unit, a first ultraviolet reaction unit, and a second ultraviolet reaction unit connected in sequence, and the oxidant addition unit is connected to the wastewater to be treated. The first ultraviolet reaction unit comprises several first ultraviolet reactors in which several first ultraviolet lamps are provided, and the second ultraviolet reaction unit comprises several second ultraviolet reactors in which several second ultraviolet lamps are provided. The first ultraviolet reactor meets the requirement that the residence time of the wastewater to be treated in the first ultraviolet reactor is t₁; the second ultraviolet reactor meets the requirement that the residence time of the wastewater to be treated in the second ultraviolet reactor is t₂; the residence time t₁ is less than the residence time t₂, and the power of the first ultraviolet lamp is greater than that of the second ultraviolet lamp.

Ultraviolet photocatalytic oxidation technology is used to treat the wastewater to be treated. The wastewater to be treated passes through the first ultraviolet reactors in the first ultraviolet reaction unit, and under conditions of higher ultraviolet intensity, higher oxidant concentration, and lower residence time, the organic matters in the wastewater can be rapidly oxidized. The wastewater then passes through the second ultraviolet reactors of the second ultraviolet reaction unit, and under conditions of lower ultraviolet intensity, lower oxidant concentration, and higher residence time, the organic matters in the wastewater undergo further deep oxidation. On the one hand, by the action of oxidants and ultraviolet light, strong oxidizing free radicals are generated to achieve thorough oxidation of organic pollutants and generate water and carbon dioxide without secondary pollution. On the other hand, the rapid oxidation stage and deep oxidation stage, through the segmented gradient oxidation process, greatly improve the utilization rate and oxidation effect of oxidants d, and reduce operating costs. The organic wastewater from contaminated sites is treated by using the ultraviolet photocatalytic oxidation technology as the core process, and strong oxidizing free radicals are generated by the action of ultraviolet light and oxidant, which thoroughly oxidizes the organic matters and finally produces water and carbon dioxide without secondary pollution. Moreover, the wastewater to be treated can meet the standard after being treated.

The tail gas treatment unit in the system comprises several adsorption towers, which are filled with absorbent resin for adsorbing VOCs in the tail gas. The absorbent resin meets the requirement of a specific surface area of ≥1000 m²/g, so that it has the advantage of stable performance and can be used for a long time without replacement.

(2) for the comprehensive treatment system for organic wastewater and tail gas of contaminated sites provided according to the present invention, the system occupies a small area and is easy to skid-mount, install, disassemble, and transport; moreover, the system has the advantages of high degree of automation, good treatment effect, stable operation, and low treatment cost or the like.

(3) The various device units used in the comprehensive treatment system for organic wastewater and tail gas of contaminated sites provided according to the present invention can be combined and applied in different quantities according to treatment requirements, and the layout can be easily changed. Thus, the system can be applied to different types of organic contaminated sites such as chemicals, petroleum, pesticides or the like to treat organic wastewater such as petroleum hydrocarbons, halogenated hydrocarbons, phenols, and benzene series, as well as volatile organic tail gas, and meet emission standards, and thus it has a very broad application market.

### BRIEF DESCRIPTION OF THE DRAWINGS

Hereinafter, the technical solutions of the present invention will be further detailed with reference to the accompanying drawings and embodiments. However, it should be appreciated that these drawings are only designed for the purpose of explanation and therefore do not limit the scope of the present invention. Furthermore, unless otherwise specified, these drawings are only intended to conceptually illustrate the structural construction described herein and are not necessarily drawn to scale.

FIG. 1 is a structural schematic diagram of a collaborative treatment system for wastewater and tail gas to be treated in contaminated sites provided according to the present invention.

FIG. 2 is a schematic diagram of an automatic control system of the collaborative treatment system for wastewater and tail gas to be treated in contaminated sites provided according to the present invention.

FIG. 3 is a structural schematic diagram of a first ultraviolet reaction unit in one usage state according to the present invention.

FIG. 4 is a structural schematic diagram of the first ultraviolet reaction unit in another usage state according to the present invention.

FIG. 5 is a structural schematic diagram of the first ultraviolet reaction unit in another usage state according to the present invention.

FIG. 6 is a schematic diagram of a top view of the structure of a second ultraviolet reactor according to the present invention.

### DESCRIPTIONS OF REFERENCE NUMBERS IN THE SCHEMATIC DIAGRAMS

100. Wastewater treatment unit;
110. Oxidant addition unit;
111. Oxidant storage tank;
112. First metering pump;
120. First ultraviolet reaction unit;
121a. First ultraviolet reactor a;
121b. First ultraviolet reactor b;
121c. First ultraviolet reactor c;
1211. First ultraviolet lamp;
130. Second ultraviolet reaction unit;
131a. Second ultraviolet reactor a;
131b. Second ultraviolet reactor b;
1311. Second ultraviolet lamp;
14. First flowmeter;
15. Temperature sensor;
16. pH sensor;
171. Valve a;
172. Valve b;
173. Valve c;
174. Valve d;
175. Valve e;
176. Valve f;
177. Valve g;
178. Valve h;
179. Valve i;
180. Acid solution addition unit;
181. Acid solution storage tank;
182. Second metering pump;
200. Tail gas treatment unit;
21. Adsorption tower a;
22. Adsorption tower b;
23. Second flowmeter;
241. Valve j;
242. Valve k;
243. Valve L;
244. Valve m;
245. Valve n;
246. Valve o;
300. Automatic control unit.

### DETAILED DESCRIPTION OF THE INVENTION

The present disclosure can be appreciated more easily from the following description in combination with examples, and all the examples constitute a part of the present disclosure. It should be appreciated that, the present disclosure is not limited to the specific products, methods, conditions, or parameters described and/or illustrated herein. Furthermore, the terms used herein are only intended to describe specific embodiments by way of examples and are not intended to be limiting, unless otherwise specified.

It should also be appreciated that for clarity, certain features of the present disclosure may be described herein in the context of individual embodiments, but may also be provided in combination with each other in a single embodiment. That is, unless it is clearly incompatible or specifically excluded, each individual embodiment is considered to be combinable with any other embodiments, and the combination is considered to represent another different embodiment. On the contrary, for the sake of simplicity, various features of the present disclosure described in the context of a single embodiment may also be provided individually or in any sub-combination. Finally, although specific embodiments may be described as parts of a series of steps or parts of more general structures, each step or substructure itself may also be considered as an independent embodiment.

Unless otherwise specified, it should be appreciated that each individual element in the list and each combination of individual elements in the list will be interpreted as different embodiments. For example, the list of embodiments represented as “A, B, or C” should be interpreted as including embodiments “A”, “B”, “C”, “A or B”, “A or C”, “B or C”, or “A, B, or C”.

In the present disclosure, the singular forms of articles “a/an”, “one”, and “the” also include corresponding plural referents, and references to specific numerical values include at least the specific value, unless otherwise explicitly stated in the context. Therefore, for example, the reference to “substance”is the reference to at least one of this substance and its equivalents.

Terms including ordinal numbers such as “first” and “second” may be used to explain various components or fluids, but these components and fluids are not limited by these terms. Therefore, without departing from the teachings of the present disclosure, these terms are only used to distinguish this component/fluid from another component/fluid.

When describing an item using binding terms such as “. . . and/or . . . ”, the description should be appreciated as including any one of the associated items listed, as well as all combinations of one or more of the items.

Generally, the use of the term “about” refers to an approximate value that can vary based on the expected characteristics obtained through the disclosed subject matter, and will be interpreted in a context dependent manner based on functionality. Therefore, those of ordinary skilled in the art will be able to explain certain degrees of differences on a case-by-case basis. In some cases, the number of important digits used to express a specific value may be a representative technique for determining the differences allowed by the term “about”. In other cases, gradients in a series of values may be used to determine the range of differences allowed by the term “about”. Further, all ranges disclosed in the present disclosure are inclusive and combinable, and references to values within a range include each value within the range.

Unless otherwise defined, all technical and scientific terms used herein have the same meanings as those commonly understood by those skilled in the art belonging to the present invention. The term and/or used herein include any and all combinations of one or more associated items listed.

Embodiments described below for which specific conditions are not specified shall be conducted according to the conventional conditions or conditions recommended by the manufacturers. The used reagents or instruments for which the manufacturers are not specified are conventional products that can be obtained through commercial purchase.

The present invention will be further illustrated hereinafter with reference to specific embodiments, but the embodiments do not limit the present invention in any form. Unless otherwise specified, the reagents, methods, and equipment used in the present invention are conventional reagents, methods, and equipment in the art. The essential features and significant effects of the present invention can be reflected in the following embodiments, which are a part but not all of the embodiments of the present invention. Therefore, these embodiments do not limit the present invention in any way, and some non-essential improvements and adjustments made by those skilled in the art based on the content of the present invention are all within the scope claimed in the present invention.

### EXAMPLE 1

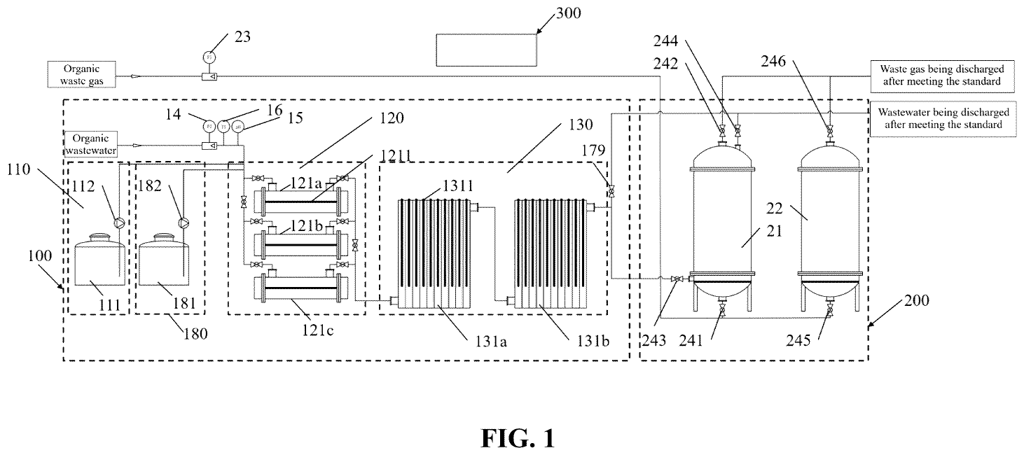

Referring to FIG. 1, a comprehensive treatment system for organic wastewater and tail gas of contaminated sites in this embodiment comprises a wastewater treatment unit 100 and a tail gas treatment unit 200, and the wastewater treatment unit 100 comprises an oxidant addition unit 110, a first ultraviolet reaction unit 120, and a second ultraviolet reaction unit 130 connected in sequence. The oxidant addition unit 110 is connected to the wastewater to be treated, i.e., the organic wastewater obtained after the extraction and separation, and is configured to add oxidants to the wastewater to be treated. The oxidants can generate strong oxidizing free radicals under the action of ultraviolet light, such as hydrogen peroxide and persulfate.

The first ultraviolet reaction unit 120 comprises several first ultraviolet reactors in which several first ultraviolet lamps 1211 are provided. One or more first ultraviolet reactors may be provided. Usually, the number of the first ultraviolet reactors is not less than 2, and in this case, the series/parallel connection mode of the first ultraviolet reactors can be switched to deal with the wastewater to be treated at different concentrations and different flow rates. The first ultraviolet reactors should meet the requirement that the residence time of the wastewater to be treated in the first ultraviolet reactors is t_{1.}

The second ultraviolet reaction unit 130 comprises several second ultraviolet reactors in which several second ultraviolet lamps 1311 are provided. One or more second ultraviolet reactors may be provided. Usually, the number of the second ultraviolet lamps 1311 is not less than 2, and in this case, the second ultraviolet reactors are connected in series. The second ultraviolet reactor should meet the requirement that the residence time of the wastewater to be treated in the second ultraviolet reactor is t₂. The residence time t₁ is less than the residence time t₂, and the power of the first ultraviolet lamp 1211 is greater than that of the second ultraviolet lamp 1311. In order to meet the above conditions of residence time, the first ultraviolet reactor may be a tubular reactor, and the second ultraviolet reactor may be a trough reactor.

It should be noted that, ultraviolet photocatalytic oxidation technology is used to treat the wastewater. The wastewater passes through the first ultraviolet reactors in the first ultraviolet reaction unit 120, and under conditions of higher ultraviolet intensity, higher oxidant concentration, and lower residence time, the organic matters in the wastewater can be rapidly oxidized, and this stage can be called the rapid oxidation stage. The wastewater then passes through the second ultraviolet reactors of the second ultraviolet reaction unit 130, and under conditions of lower ultraviolet intensity, lower oxidant concentration, and higher residence time, the organic matters in the wastewater undergo further deep oxidation, and this stage can be called the deep oxidation stage. By the action of oxidants and ultraviolet light, strong oxidizing free radicals are generated to achieve thorough oxidation of organic pollutants and generate water and carbon dioxide without secondary pollution generation. On the other hand, the oxidation process includes a rapid oxidation stage and a deep oxidation stage, and through the segmented gradient oxidation process, the wastewater can meet the standard, the utilization rate and oxidation effect of oxidants are greatly improved, and operating costs are reduced.

The tail gas treatment unit 200 includes several adsorption towers which are connected in parallel. The adsorption towers are filled with absorbent resin for adsorbing VOCs in the tail gas, that is, VOCs in the organic waste gas obtained by extraction and separation. The absorbent resin meets the condition of a specific surface area of ≥1000 m²/g. The adsorbent resin can effectively remove VOCs from the tail gas through adsorption so that the tail gas meets the standards Preferably, reference may be made to the invention patent with publication number CN102391407A for the absorbent resin, and the absorbent resin is stable in performance and can be used for a long time without replacement or supplement. In addition, the particle size of the absorbent resin may be 0.6-1.25 mm.

Further, the wastewater to be treated is organic wastewater extracted and separated from the soil in the contaminated sites by the multiphase extraction system; while the tail gas is organic waste gas extracted and separated from the soil in the contaminated sites by the multiphase extraction system.

As a specific embodiment, the wastewater meeting the standards may mean that the wastewater meets the indirect discharge limit standards in Table 1 of the national standard GB 31571-2015 or the direct discharge limit standards in Table 1 of the national standard GB 31571-2015; and the wastewater not meeting the standards may mean that the wastewater fails to meet the indirect discharge limit standards in Table 1 of the national standard GB 31571-2015.

The tail gas meeting the standards may mean that the tail gas meets the third-level standards and unorganized emission concentration limit standards in Table 2 of the national standard GB 16297-1996.

For example, the wastewater to be treated can meet the indirect discharge limit standards in Table 1 of the national standard GB 31571-2015 after being treated by the first ultraviolet reaction unit 120 and the second ultraviolet reaction unit 130. At this point, the wastewater that meets the standards will be indirectly discharged, for example, it is collected and transported to a sewage treatment plant for further treatment. When the concentration of the wastewater to be treated is low, the treated wastewater can further meet the direct discharge limit standards in Table 1 of GB 31571-2015 on the basis of meeting the indirect discharge limit standards in Table 1 of the national standard GB 31571-2015. At this point, the wastewater that meets the standards can be directly discharged, for example, it can be discharged into the urban sewage pipe network on site.

Specifically, the residence time t₁ of the wastewater to be treated in the first ultraviolet reactor is 0.5-5 minutes; and the residence time t ₂ of the wastewater to be treated in the second ultraviolet reactor is 10-100 minutes.

Further, the first ultraviolet lamps 1211 are arranged parallel to the direction of water flow within the first ultraviolet reactor. By arranging the first ultraviolet lamps 1211 along the axis of the water flow direction, the structure of the first ultraviolet reactor can be made more compact to reduce its volume, which helps to reduce the overall footprint of the system. On the other hand, in order to achieve the effect of rapid oxidation, the power of the first ultraviolet lamps 1211 should be greater than 1 kW. Moreover, the wavelength of ultraviolet light emitted by the first ultraviolet lamps 1211 is 200-400 nm. In addition, the number of the first ultraviolet lamps 1211 may be adjusted according to the volume of the first ultraviolet reactor. Generally, the number of the first ultraviolet lamps 1211 increases as the volume of the first ultraviolet reactor increases.

Referring to FIG. 6, the second ultraviolet lamps 1311 are arranged perpendicular to the direction of water flow, and the power of the second ultraviolet lamps 1311 is less than 1 kW. Through such arrangement, maintenance and replacement can be carried out from the top of the second ultraviolet reactor, thereby saving space. On the other hand, the wavelength of ultraviolet light emitted by the second ultraviolet lamps 1311 is mainly 254 nm. In addition, the number of the second ultraviolet lamps 1311 may also be adjusted according to the volume of the second ultraviolet reactor. Even further, lamps with adjustable power may be selected as the first ultraviolet lamp 1211 and the second ultraviolet lamp 1311, and the power of the first ultraviolet lamp 1211 and the second ultraviolet lamp 1311 can be adjusted according to the concentration and flow rate of the wastewater to be treated.

The oxidant addition unit 110 comprises an oxidant storage tank 111 and a first metering pump 112, and the first metering pump 112 is connected to the oxidant storage tank 111 and the first ultraviolet reaction unit 120 respectively. The oxidant storage tank 111 stores oxidants, which can generate strong oxidizing free radicals under the action of ultraviolet light. Preferably, the first metering pump 112 can add oxidant to the wastewater to be treated before the wastewater to be treated enters the first ultraviolet reactor. The oxidant is at least one of hydrogen peroxide and persulfate. For example, persulfate may be sodium persulfate or potassium persulfate. Preferably, the oxidant is hydrogen peroxide, for which the reduction product is water, so it is greener and safer.

To enhance the oxidation effect of the oxidant, acid solution may be added to the wastewater to be treated. The acid solution is used to adjust the pH value of the wastewater to be treated and may be one, two or more of hydrochloric acid or sulfuric acid. In practical applications, dilute sulfuric acid or dilute hydrochloric acid with low concentrations may be used. Specifically, the acid solution is added by the acid solution addition unit 180 in the wastewater treatment unit 100. The acid solution addition unit 180 includes an acid solution storage tank 181 and a second metering pump 182, and the second metering pump 182 is connected to the acid solution storage tank 181 and the first ultraviolet reaction unit 120 respectively.

Moreover, a mixer, such as a pipeline mixer, may be installed between the first ultraviolet reaction unit 120 and the acid solution addition unit 180. The oxidant and acid solution, after being added to the wastewater to be treated, are mixed evenly with the wastewater to be treated through the mixer, which is beneficial for achieving the desired oxidation effect after the subsequent ultraviolet photocatalytic oxidation.

Further, the second ultraviolet reaction unit 130 is connected to the tail gas treatment unit 200. When the wastewater to be treated after passing through the second ultraviolet reaction unit 130 fails to meet the standard, some adsorption towers in the tail gas treatment unit 200 are used to adsorb pollutants in the wastewater to make it meet the standard. Specifically, a detector may be provided on the water outlet pipeline of the second ultraviolet reaction unit 130 to monitor and obtain the concentration of pollutants or the like in the wastewater to be treated, in order to determine whether it is necessary to introduce the wastewater into the adsorption tower again for treatment.

A first flowmeter 14, a temperature sensor 15, and a pH sensor 16 are provided between the first ultraviolet reaction unit 120 and the wastewater to be treated. A second flowmeter 23 is provided between the tail gas treatment unit 200 and the tail gas, which can monitor the real-time flow rate, temperature, pH of the wastewater to be treated, as well as the real-time flow rate of the tail gas so as to make timely adjustments to the system, e.g., to reduce the flow rate.

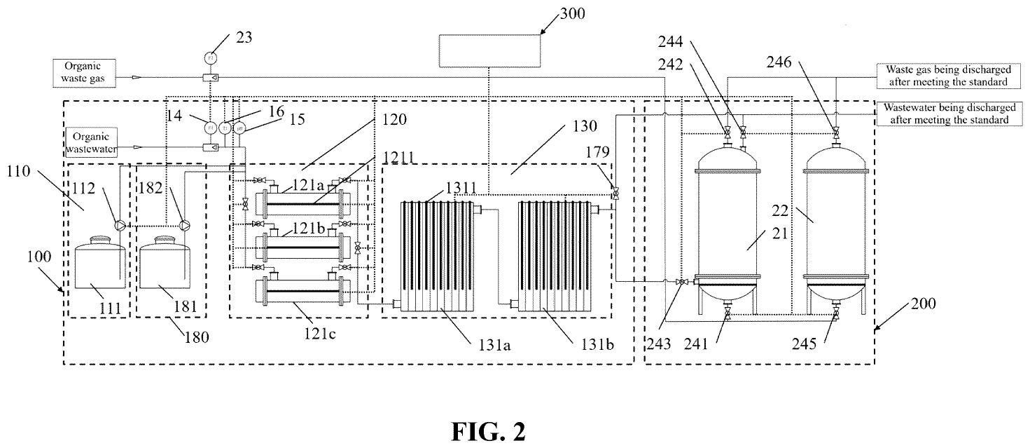

Referring to FIG. 2, the system further comprises an automatic control unit 300, which is electrically connected to the wastewater treatment unit 100, the tail gas treatment unit 200, the oxidant addition unit 110, and the acid solution addition unit 180.

The automatic control unit 300 may be a programmable logic controller, and the system automatically controls individual units through the control panel on the automatic control unit 300, including adjusting the power of the ultraviolet reactors. The values of all instruments and the operating status of equipment can all be viewed and controlled through the control panel of the automatic control unit 300, and manual control and parameter modification can be performed, thereby realizing a high degree of automation.

For example, based on the flow rate, temperature, pH and other water quality indicators of the wastewater to be treated monitored by the first flowmeter 14, the temperature sensor 15 and the pH sensor 16, and the input concentration data of pollutants, the dosages of oxidant and acid solution that need to be added can be calculated according to the target oxidant concentration set by the system, and the first metering pump 112 and the second metering bump 182 are intelligently controlled to respectively add certain amounts of oxidant and acid solution to the wastewater to be treated, which can effectively avoid waste caused by excessive addition of chemicals.

Based on the flow rate, temperature, pH and other water quality indicators of the wastewater to be treated monitored by the first flowmeter 14, the temperature sensor 15 and the pH sensor 16, and the input concentration data of pollutants, the required UV intensity may also be calculated according to the target UV dosage set by the system, and the power of the first ultraviolet lamp 1211 and the second ultraviolet lamp 1311 is intelligently controlled, thereby avoiding energy waste.

For the comprehensive treatment system for organic wastewater and tail gas of contaminated sites of this embodiment, the system occupies a small area and is easy to skid-mount, install, disassemble, and transport; moreover, the system has the advantages of high degree of automation, good treatment effect, stable operation, and low treatment cost or the like.

Moreover, components of the system can be combined and applied in different quantities according to treatment requirements, and the layout can be easily changed. Therefore, the system can be applied to different types of organic contaminated sites such as chemicals, petroleum, pesticides or the like to treat organic wastewater such as petroleum hydrocarbons, halogenated hydrocarbons, phenols, and benzene series, as well as volatile organic tail gas, and meet emission standards. Moreover, the system has advantages of small occupied area, high degree of automation, stable operation, low treatment cost or the like.

As a specific embodiment, the first ultraviolet reaction unit 120 includes a first ultraviolet reactor a121a, a first ultraviolet reactor b121b, and a first ultraviolet reactor c121c. The first ultraviolet reactor a121a is provided with an interface a and an interface b, the first ultraviolet reactor b121b is provided with an interface c and an interface d, and the first ultraviolet reactor c121c is provided with an interface e and an interface f, the interfaces a, c, and e are respectively connected to the oxidant addition unit 110 and the wastewater to be treated through pipelines, while the interfaces b, d, and f are connected to the second ultraviolet reaction unit 130 through pipelines.

It should be noted that, when the flow rate of the wastewater to be treated is small and the concentration of pollutants is high, the first ultraviolet reactors a121a, b121b and c121c are allowed to be connected in series by adjusting the pipeline connection or the like, e.g., by removing the pipelines connecting interfaces c and e to the wastewater to be treated and the pipelines connecting interfaces b and d to the second ultraviolet reaction unit 130, and adding the pipelines connecting interfaces b and c and the pipelines connecting interfaces d and e, which can increase the treatment time at higher ultraviolet intensity and higher oxidant concentration and achieve rapid oxidation of high-concentration pollutants.

When the flow rate of the wastewater to be treated is larger and the concentration is lower, the first ultraviolet reactors a121a, b121b and c121c are allowed to be connected in parallel so that the multiple first ultraviolet reactors can be used simultaneously for treatment, which can achieve rapid oxidation of a large amount of wastewater to be treated and maintain a good oxidation effect.

On the other hand, one of the first ultraviolet reactors also may be switched out of the system for cleaning, repair or the like by adjusting the connection of the pipelines or the like. For example, similar methods of removing and adding pipelines described above may be used, which will not be further described herein. Taking the case where the first ultraviolet reactor a121a is switched out as an example, when it is necessary to clean the first ultraviolet reactor a121a, the first ultraviolet reactor b121b and the first ultraviolet reactor c121c keep running, and the wastewater is not allowed to pass through the first ultraviolet reactor a121a. Since there is no wastewater flowing through the first ultraviolet reactor a121a, it is convenient to maintain and clean the first ultraviolet reactor a121a while the system continuously operates. Similarly, other first ultraviolet reactors can be maintained and cleaned while the system continuously operates. When the first ultraviolet reaction unit 120 is provided with four or more first ultraviolet reactors, the connection may be implemented in the similar manner and this will not be further described herein.

The second ultraviolet reaction unit 130 comprises a second ultraviolet reactor a131a and a second ultraviolet reactor b131b connected in series. The second ultraviolet reactor a131a comprises a water inlet a and a water outlet a, and the second ultraviolet reactor b131b comprises a water inlet b and a water outlet b. The water inlet a of the second ultraviolet reactor a131a is connected to the first ultraviolet reactor c121c, the water outlet a is connected to the water inlet b of the second ultraviolet reactor b131b, and the water outlet b is connected to the wastewater collection device. The wastewater collection device is used to collect the wastewater that meets the standard after being treated. For example, the wastewater collection device may be a reagent storage tank. It is convenient to store and transport the wastewater to sewage treatment plants after collection, and the concentration of pollutants in the wastewater that meets the standard can also be sampled, tested, and analyzed. The second ultraviolet reaction unit 130 can also be provided with three or more second ultraviolet reactors connected in series, which will not be further described herein.

The tail gas treatment unit 200 comprises an adsorption tower a21 and an adsorption tower b22 connected in parallel. The adsorption tower a21 comprises an air inlet and an air outlet, and the adsorption tower b22 comprises an air inlet and an air outlet. The air inlet of the adsorption tower a21 and the air inlet of the adsorption tower b22 are connected to the tail gas, and the air outlet of the adsorption tower a21 and the air outlet of the adsorption tower b22 are connected to the outside. Usually, the air inlets of the adsorption towers a21 and b22 are respectively provided at the bottom thereof, and the air outlet of the adsorption towers a21 and b22 are respectively provided at the top thereof. The tail gas can be directly discharged into the atmosphere when it meets the standard after being treated. Specifically, a gas detector or the like can be provided on the pipeline connected to the air outlet of the adsorption tower to monitor and obtain the concentration of VOCs or the like in the treated tail gas.

The adsorption tower a21 also comprises a water inlet and a water outlet, wherein the water inlet of the adsorption tower a21 is connected to the water outlet b of the second ultraviolet reactor; and the water outlet of the adsorption tower a21 is connected to the wastewater collection device.

It should be noted that, when the wastewater to be treated meets the standard after being treated by the wastewater treatment unit 100, it will be discharged with standards. At this time, the adsorption tower a21 and the adsorption tower b22 are connected in parallel to treat organic waste gas. In addition, the discharge of the wastewater after meeting the standard may be performed by referring to the aforementioned standards, and this will not be further elaborated herein. When the wastewater to be treated fails to meet the standard after being treated by the wastewater treatment unit 100, it needs to be further treated by the adsorption tower a21 in order to meet the standard. At this time, the adsorption tower a21 is switched to treat the organic wastewater, while the adsorption tower b22 treats the organic waste gas.

Multiple adsorption towers connected in parallel may be provided within the tail gas treatment unit 200, or multiple of the adsorption towers therein may be respectively provided with water inlets and water outlets for treating the wastewater to be treated that does not meet the standards. However, it should be ensured at the same time that there are still a certain number of adsorption towers available for treating tail gas, and this will not be further elaborated herein.

Even further, valves may be provided on the connecting pipelines of the equipment to realize the series/parallel connection switching of multiple first ultraviolet reactors and the switching between the entrance of the wastewater to be treated into the adsorption tower a21 and discharge of the wastewater after it meets the standard.

As another specific embodiment, the first ultraviolet reactor a121a is provided with an interface a and an interface b, the first ultraviolet reactor b121b is provided with an interface c and an interface d, and the first ultraviolet reactor c121c is provided with an interface e and an interface f. The interface a on the first ultraviolet reactor a121a is connected with a valve a171, the interface b is connected with a valve b172, the interface c on the first ultraviolet reactor b121b is connected with a valve c173, the interface d is connected with a valve d174, the interface e on the first ultraviolet reactor c121c is connected with a valve e175, and the interface f is connected with a valve f176.

The valves a171, c173, and e175 are connected to the wastewater to be treated through water inlet pipelines, while the valves b172, d174, and f176 are connected to the second ultraviolet reaction unit 130 through water outlet pipelines. A valve g177 is provided between the valve a171 and the valve c173 on the water inlet pipeline, and a valve h178 is provided between the valve d174 and the valve e175 on the water outlet pipeline.

As shown in FIG. 3, when the valves a171, b172, c173, d174, e175, and f176 are opened and the valves g177 and h178 are closed, the first ultraviolet reactors a121a, b121b, and c121c are connected in series, and the wastewater to be treated needs to flow through the first ultraviolet reactors a121a, b121b, and c121c in sequence as indicated by the arrows in the figure.

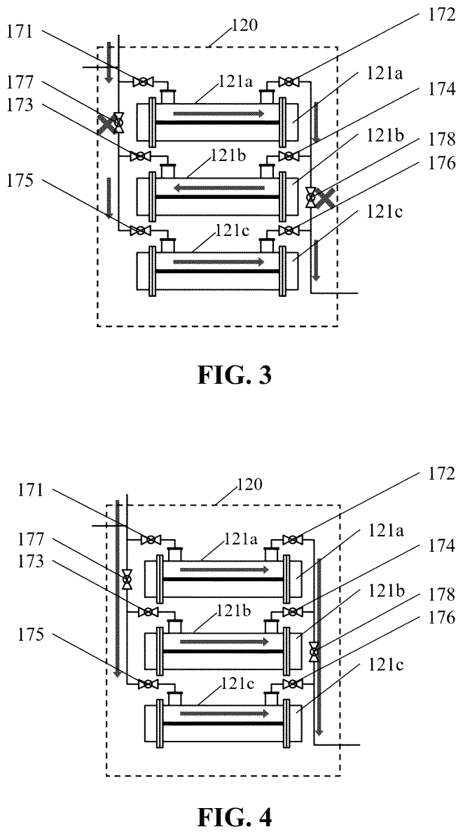

As shown in FIG. 4, when the valves a171, b172, c173, d174, e175, f176, g177 and h178 are all opened, the first ultraviolet reactors a121a, b121b, and c121c are connected in parallel, and the wastewater to be treated is divided into three streams to flow through the first ultraviolet reactors a121a, b121b, and c121c respectively as indicated by the arrows in the figure.

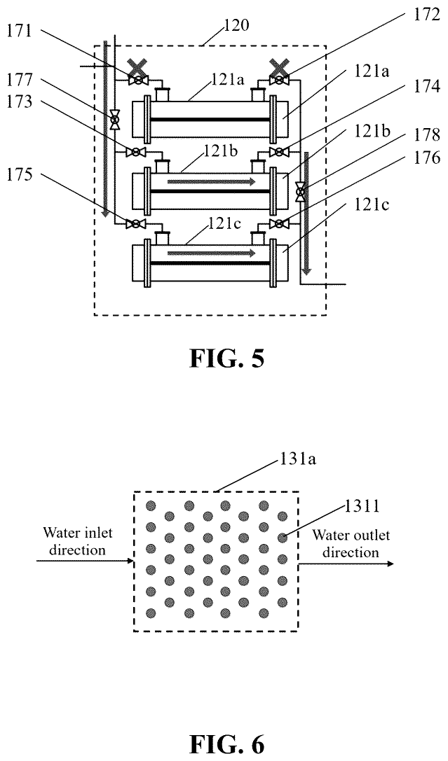

As shown in FIG. 5, when the valves a171 and b172 are closed, and the valves c173, d174, e175, f176, g177, and h178 are all opened, the first ultraviolet reactor a121a is switched out, and the first ultraviolet reactors b121b and c121c are connected in parallel. The flow direction of the wastewater to be treated is as indicated by the arrow in the figure. At this time, there is no wastewater to be treated flowing through the first ultraviolet reactor a121a so that the first ultraviolet reactor a121a can be cleaned or repaired or the like, while the first ultraviolet reactors b121b and c121c treat the wastewater to be treated normally.

In addition, a valve i179 is provided on the pipeline connecting the interface f of the first ultraviolet reactor c121c to the wastewater collection device;

a valve j241 is connected to the air inlet of the adsorption tower a21, and a valve k242 is connected to the air outlet of the adsorption tower a21;

a valve L243 is connected to the water inlet of the adsorption tower a21, and a valve m244 is connected to the water outlet of the adsorption tower a21;

a valve n245 is connected to the air inlet of the adsorption tower b22, and a valve o246 is connected to the air outlet of the adsorption tower b22.

When the wastewater meets the standard after being treated by the ultraviolet photocatalytic oxidation unit, the valve i179 is opened, and the valves L243 and m244 are closed for discharging the wastewater. At this time, the adsorption tower a21 and the adsorption tower b22 are opened and connected in parallel to treat the tail gas.

When the wastewater fails to meet the standard after being treated by the ultraviolet photocatalytic oxidation unit, the valve i179 is closed, the valves j241, k242, n245, o246, L243, and m244 are opened, the adsorption tower a21 treats the wastewater to be treated, and the adsorption tower b22 treats the tail gas.

Moreover, the above-mentioned valves may be solenoid valves and electrically connected to the automatic control unit 300 to automatically control the opening and closing of the valves.

### EXAMPLE 2

This example provides a treatment process for wastewater and tail gas treatment by using the comprehensive treatment system for organic wastewater and tail gas of contaminated sites in Example 1, which comprises the following procedures: allowing the extracted and separated organic wastewater to enter the first ultraviolet reaction unit 120 through the pipeline, and before the organic wastewater entering the first ultraviolet reaction unit 120, adding oxidants and acid solution to the wastewater to be treated through the first metering pump 112 and the second metering pump 182 in the oxidant addition unit 110 and the acid solution addition unit 180. After the wastewater entering the first ultraviolet reaction unit 120, under the conditions of higher UV intensity, higher oxidant concentration, and lower residence time, the organic matters in the wastewater can be quickly oxidized, and then the wastewater to be treated enters the second ultraviolet reaction unit 130, where the organic matters in the wastewater undergo further deep oxidation by strong oxidizing free radicals generated through the actions of oxidants and ultraviolet light under conditions of lower UV intensity, lower oxidant concentration, and higher residence time. The organic pollutants are thoroughly oxidized into water and carbon dioxide without generating secondary pollution generation, and through the segmented gradient oxidation process, the utilization rate and oxidation effect of oxidants are improved and operating costs are reduced.

When the flow rate of the wastewater to be treated is small and the concentration of organic matter is too high, the first ultraviolet reactors a121a, b121b, and c121c in the first ultraviolet reaction unit 120 can be switched to be connected in series to prolong the rapid oxidation time and achieve a better oxidation effect. When the flow rate of the wastewater to be treated is large and the concentration of organic matter is lower, the first ultraviolet reactors a121a, b121b, and c121c in the first ultraviolet reaction unit 120 can be switched to be connected in parallel so that the three reactors can be used simultaneously to complete the treatment of a large amount of wastewater to be treated.

On the other hand, the extracted and separated organic waste gas enters the adsorption tower in the tail gas unit to be adsorbed by the absorbent resin filled in the adsorption tower. Reference may be made to the invention patent with publication number CN102391407A for the absorbent resin, and the absorbent resin is stable in performance, easy to regenerate, and can be used for a long time without replacement or supplement.

Moreover, if the wastewater to be treated still fails to meet the standard after being treated by the first ultraviolet reaction unit 120 and the second ultraviolet reaction unit 130, then it can be introduced into some adsorption towers in the tail gas treatment unit 200 to remove organic matters through adsorption so as to meet the standard.

Further, a first flowmeter 14, a temperature sensor 15, and a pH sensor 16 are provided between the first ultraviolet reaction unit 120 and the wastewater to be treated; and a second flowmeter 23 is provided between the tail gas treatment unit 200 and the tail gas.

The system further comprises an automatic control unit 300, which is electrically connected to the wastewater treatment unit 100, the tail gas treatment unit 200, the oxidant addition unit 110, and the acid solution addition unit 180.

The automatic control unit 300 may be a programmable logic controller, and the system can achieve automatic control of various units, including adjusting the power of the ultraviolet lamps. The values of various instruments and the operating status of equipment in respective units can all be viewed and controlled through the control panel of the automatic control unit 300, and various operating parameters and operating statuses of the system can be adjusted.

What is claimed is:

1. A comprehensive treatment system for organic wastewater and tail gas of contaminated sites, characterized in that,
it comprises a wastewater treatment unit (100) and a tail gas treatment unit (200),
wherein the wastewater treatment unit (100) comprises an oxidant addition unit (110), a first ultraviolet reaction unit (120) and a second ultraviolet reaction unit (130) connected in sequence;
the oxidant addition unit (110) is connected to the wastewater to be treated and is used to add oxidants to the wastewater to be treated;
the first ultraviolet reaction unit (120) comprises several first ultraviolet reactors in which several first ultraviolet lamps (1211) are provided; when the number of the first ultraviolet reactors is ≥2, the series/parallel connection mode of the first ultraviolet reactors can be switched, and the first ultraviolet reactors meet the requirement that the residence time of the wastewater to be treated in the first ultraviolet reactors is t₁;
the second ultraviolet reaction unit (130) comprises several second ultraviolet reactors in which several second ultraviolet lamps (1311) are provided; when the number of the second ultraviolet reactors is ≥2, the second ultraviolet reactors are connected in series; and the second ultraviolet reactors meet the requirement that the residence time of the wastewater to be treated in the second ultraviolet reactors is t₂;
the residence time t₁ is less than the residence time t₂, and the power of the first ultraviolet lamp (1211) is greater than that of the second ultraviolet lamp (1311);
the tail gas treatment unit (200) comprises several adsorption towers, which are connected in parallel and filled with absorbent resin; the absorbent resin needs to meet the requirement of a specific surface area of ≥1000 m²/g.

2. The comprehensive treatment system for organic wastewater and tail gas of contaminated sites according to claim 1, characterized in that,
the first ultraviolet lamps (1211) are arranged parallel to the direction of water flow.

3. The comprehensive treatment system for organic wastewater and tail gas of contaminated sites according to claim 1, characterized in that,
the second ultraviolet lamps (1311) are arranged perpendicular to the direction of water flow.

4. The comprehensive treatment system for organic wastewater and tail gas of contaminated sites according to claim 1, characterized in that,
the oxidant addition unit (110) comprises an oxidant storage tank (111) and a first metering pump (112),
the first metering pump (112) is connected to the oxidant storage tank (111) and the first ultraviolet reaction unit (120) respectively.

5. The comprehensive treatment system for organic wastewater and tail gas of contaminated sites according to claim 4, characterized in that,
the wastewater treatment unit (100) further comprises an acid solution addition unit (180) which includes an acid solution storage tank (181) and a second metering pump (182),
the second metering pump (182) is connected to the acid solution storage tank (181) and the first ultraviolet reaction unit (120) respectively.

6. The comprehensive treatment system for organic wastewater and tail gas of contaminated sites according to claim 5, characterized in that,
the second ultraviolet reaction unit (130) is connected to the tail gas treatment unit (200);
when the wastewater treated by the second ultraviolet reaction unit (130) fails to meet the standard, some of the adsorption towers in the tail gas treatment unit (200) are used to adsorb pollutants in the wastewater.

7. The comprehensive treatment system for organic wastewater and tail gas of contaminated sites according to claim 6, characterized in that,
it further comprises an automatic control unit (300) which is electrically connected to the wastewater treatment unit (100), the tail gas treatment unit (200), the oxidant addition unit (110) and the acid solution addition unit (180).

8. The comprehensive treatment system for organic wastewater and tail gas of contaminated sites according to claim 7, characterized in that,
the first ultraviolet reaction unit (120) comprises a first ultraviolet reactor a (121a), a first ultraviolet reactor b (121b), and a first ultraviolet reactor c (121c);
the first ultraviolet reactor a (121a) is provided with an interface a and an interface b,
the first ultraviolet reactor b (121b) is provided with an interface c and an interface d,
the first ultraviolet reactor c (121c) is provided with an interface e and an interface f,
the interfaces a, c, and e are respectively connected to the oxidant addition unit (110) and the wastewater to be treated through pipelines, while the interfaces b, d, and f are connected to the second ultraviolet reaction unit (130) through pipelines.

9. The comprehensive treatment system for organic wastewater and tail gas of contaminated sites according to claim 7, characterized in that,
the tail gas treatment unit (200) comprises an adsorption tower a (21) and an adsorption tower b (22) connected in parallel;
the adsorption tower a (21) comprises an air inlet, an air outlet, a water inlet, and a water outlet, and the adsorption tower b (22) comprises an air inlet and an air outlet;
the air inlet of the adsorption tower a (21) and the air inlet of the adsorption tower b (22) are connected to tail gas, and the air outlet of the adsorption tower a (21) and the air outlet of the adsorption tower b (22) are both in communication with the outside;
the water inlet of the adsorption tower a (21) is connected to the second ultraviolet reaction unit (130), and the water outlet of the adsorption tower a (21) is connected to a wastewater collection device.

10. A process for wastewater and tail gas treatment by using the comprehensive treatment system for organic wastewater and tail gas of contaminated sites according to claim 1, characterized in that, it comprises the following procedures:
adding oxidant and acid solution to the wastewater to be treated, then allowing the wastewater to be treated to enter the first ultraviolet reaction unit (120) and then pass through the second ultraviolet reaction unit (130), and performing ultraviolet photocatalytic oxidation treatment in the first ultraviolet reaction unit (120) and the second ultraviolet reaction unit (130);
introducing the tail gas into the adsorption tower in the tail gas treatment unit (200) for adsorption treatment;
discharging the wastewater if the wastewater to be treated meets the standard after the ultraviolet photocatalytic oxidation treatment; and treating the wastewater by some adsorption towers in the tail gas treatment unit (200) if the wastewater fails to meet the standards.

11. The process for wastewater and tail gas treatment according to claim 10, wherein the first ultraviolet reactors meet the requirement that the residence time of the wastewater to be treated in the first ultraviolet reactors is t₁;
the second ultraviolet reactors meet the requirement that the residence time of the wastewater to be treated in the second ultraviolet reactors is t₂;
and the residence time t₁ is less than the residence time t₂, and the power of the first ultraviolet lamp (1211) is greater than that of the second ultraviolet lamp (1311).
